(19) United States
(12) Patent Application Publication
(10) Pub. No.: US 2026/0356282 A1
(43) Pub. Date: Nov. 12, 2026

(54) BUGGY LIGHT

(71) Applicant: Dennis Osborne, Lancaster, OH (US)

(72) Inventor: Dennis Osborne, Lancaster, OH (US)

(21) Appl. No.: 19/199,468

(22) Filed: May 6, 2025

(51) Int. Cl. B60Q 1/26; B60Q 1/46; F21S 13/00; F21S 43/00; F21S 43/13; F21S 45/20; F21S 45/37; F21V 9/40; F21V 11/18; F21W 107/10

(52) U.S. Cl. CPC B60Q 1/2607; B60Q 1/46; F21S 13/00; F21S 43/13; F21S 43/601; F21S 45/20; F21S 45/37; F21V 9/40; F21V 11/183; B60Q 2400/20; B60Q 2900/50; F21W 2107/10

(57) ABSTRACT

A buggy light for horse-drawn vehicles provides a flashing safety signal without using electricity. The system includes a housing that holds a lantern (e.g. an oil-burning lamp) as a light source. The housing has multiple apertures with lenses and color filters (such as red and yellow) to project light in required directions. A rotating eclipser with one or more shields, driven by a spring-wound or otherwise non-electric motor, intermittently blocks the lantern's light to create a blinking effect visible from a distance. The device can be mounted on an Amish buggy to meet roadway lighting laws (including flashing yellow and red lights) while remaining compliant with Amish religious restrictions, thereby improving safety for the buggy and surrounding traffic without the use of electric power.

### CROSS-REFERENCE TO RELATED APPLICATIONS

This application claims the benefit of U.S. Provisional Application No. 63/642,967, filed May 6, 2024 the entirety of which is incorporated herein by reference.

### BACKGROUND OF THE INVENTION

The Amish community is a group that adheres to a lifestyle largely free from modern technologies as a core aspect of their religious practice. This lifestyle extends to transportation, where they favor horse-drawn buggies over motor vehicles. The use of technology is dictated by local community leaders (for example, bishops in Amish communities in Ohio) who determine what is permissible according to their beliefs and traditions. As a result, many technologies common in modern vehicles are rejected in Amish buggies for religious reasons.

The interaction of this traditional lifestyle with broader societal laws can cause friction. A significant issue is the operation of slow-moving, minimally lit horse-drawn buggies on public highways shared with fast-moving motor vehicles. The speed differential and, importantly, the lack of adequate lighting and visibility on these buggies pose a considerable risk to all road users, Amish and non-Amish alike. Modern traffic laws require vehicles to have safety lights visible at certain distances, often including flashing lights to attract attention. For the Amish, using electric lights, such as battery-powered or wired lighting, is generally forbidden by their religious principles. This creates a conundrum: how can the Amish comply with road safety laws without compromising their religious beliefs?

In practice, many Amish buggy owners have been cited for violations of lighting laws. Their typical response is to appear in court without legal counsel, plead no contest, and then refuse to pay fines. This stance demonstrates their deep conviction and unwillingness to adopt technologies that contradict their faith, even under legal penalty. In Ohio, refusing to pay fines for minor traffic infractions does not immediately result in jail; however, courts have other mechanisms to enforce compliance, and persistent non-payment can lead to contempt of court charges, which can result in incarceration. Thus, members of the Amish community face a difficult choice between violating their religious tenets or facing legal and financial consequences.

To illustrate the legal requirements at issue, consider Ohio's lighting laws for animal-drawn vehicles. In Ohio, Section 4513.114 of the Ohio Revised Code (effective Aug. 31, 2022) specifies the lighting, reflector, and emblem requirements for animal-drawn vehicles on public roads. This law aims to enhance buggy visibility, especially under low-light conditions. Key provisions of Ohio Revised Code 4513.114 include:

Front White Light: At least one lamp on the front emitting a white light visible from a distance of at least 1,000 feet. This is to alert oncoming vehicles of the buggy's presence.

Rear Red Lights/Reflectors: Either two lamps or one lamp emitting red light to the rear (visible from at least 1,000 feet), or two red reflectors visible from 600 to 100 feet to the rear under headlamp illumination. These provide visibility to approaching vehicles from behind.

Yellow Flashing Light: A yellow flashing lamp, positioned on the rear or top of the vehicle, visible from at least 1,000 feet in all directions. This flashing light must be displayed at all times to draw attention to the slow-moving vehicle.

Slow-Moving Vehicle Emblem/Reflective Tape: At least one high-visibility emblem (such as the familiar triangular Slow Moving Vehicle (SMV) emblem) and/or reflective micro-prism tape mounted as specified by law. These passive devices further ensure the buggy can be seen from a distance.

Failure to equip a buggy with the above lighting and reflective devices is a legal violation. In Ohio, non-compliance is treated as a minor misdemeanor, usually resulting in a fine. If the person cited refuses to pay the fine, the court may employ various measures to enforce payment or penalize the non-compliance. Potential consequences for continued non-payment include:

Community Service: Courts may order community service in lieu of fines, allowing the individual to fulfill their obligation through labor rather than monetary payment.

Civil Collection Remedies: Unpaid fines can be converted into a civil judgment against the individual. The state can then pursue collection through liens, wage garnishment, or other civil enforcement mechanisms to recover the debt.

Contempt of Court Charges: Persistently refusing court orders to pay can lead to contempt of court charges. In some cases, this could result in additional penalties, including possible incarceration, depending on the court's discretion.

Credit and Background Impact: Unpaid fines might be reported to credit bureaus, negatively affecting the individual's credit rating. They may also appear on background checks, potentially impacting employment, housing, or loans.

Seizure of Assets: Courts may order seizure of property or direct wage garnishment to satisfy outstanding fines, directly taking a portion of the person's assets or earnings to cover the debt.

These legal pressures underscore the seriousness of the issue. The Amish are effectively asked to choose between violating their religious prohibition on certain technologies or facing escalating legal and financial penalties. This situation has created a clear need for a solution that bridges the gap between legal requirements for safety and religious restrictions on technology.

### SUMMARY OF THE INVENTION

The present invention addresses this need by providing a lighting system that ensures both legal compliance and religious compliance. In particular, it offers a non-electric flashing buggy light that can be used on Amish horse-drawn buggies to meet the visibility standards of laws like Ohio's, without relying on electricity or other forbidden modern technologies. By repurposing traditional light sources (such as oil lanterns) and employing a mechanical flashing mechanism, this invention enables Amish buggy operators to display the required flashing lights and colors (yellow, red, etc.) on their buggies. This solution allows the Amish community to promote road safety and obey traffic laws without contravening their religious principles. In summary, the invention provides a viable, lawful, and respectful way to make Amish buggies more visible on the road, thereby reducing the risk of accidents while preserving the Amish commitment to a non-electric way of life.

### BRIEF DESCRIPTION OF DRAWINGS

FIG. 1 is an external view of the buggy light 100, showing the housing and chimney, with lens covers on each visible side.

FIG. 2 is an internal view of the buggy light 100, showing the lantern 102 positioned on a platform relative to the eclipser 112 and motor 150.

FIG. 3 is an exploded view of the buggy light, illustrating the alignment and assembly of the internal components within the housing 106.

FIG. 4 shows the buggy light 100 installed on a horse-drawn vehicle 124 (also known as a “buggy”) in use, demonstrating the typical placement and orientation of the device on the vehicle.

### DETAILED DESCRIPTION OF THE INVENTION

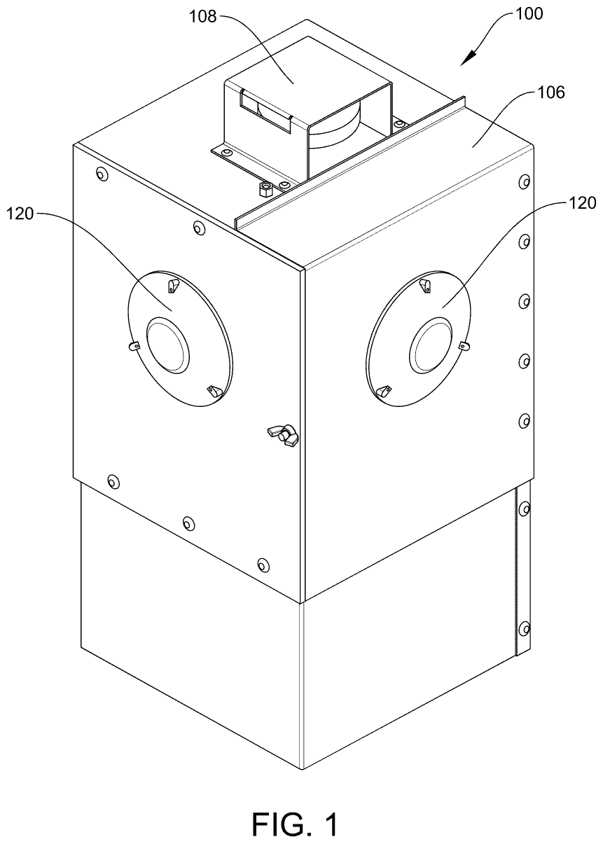

Detailed embodiments of the invention are described below with reference to the accompanying drawings (FIGS. 1-4). It is to be understood that the invention may be embodied in many different forms and should not be construed as limited to the specific examples set forth here. These examples are provided so that this disclosure is thorough and fully conveys the scope of the invention to those skilled in the art. Various changes and modifications may be made within the scope of the appended claims without departing from the spirit of the invention.

Reference Numerals: For clarity, the following reference numbers are used consistently in the drawings and description to denote the associated elements of the invention:
100—buggy light
102—lantern
104—light source
106—housing
108—chimney
110—aperture
112—eclipser
114—shield
116—horizontal support
118—lens
120—lens cover
124—vehicle
130—support
140—platform
146—base
150—motor
152—drive shaft

The following elements will be discussed but not shown in drawings, and thusly have no reference number assigned.

A gear assembly comprising gearing or pulley system for speed control

A weight, as an alternate power source, such as a weight-drive

A battery, as an alternate power source, electric

A solar panel, as an alternate power source, solar electric

Referring to FIG. 1, an external perspective of the buggy light 100 is depicted.

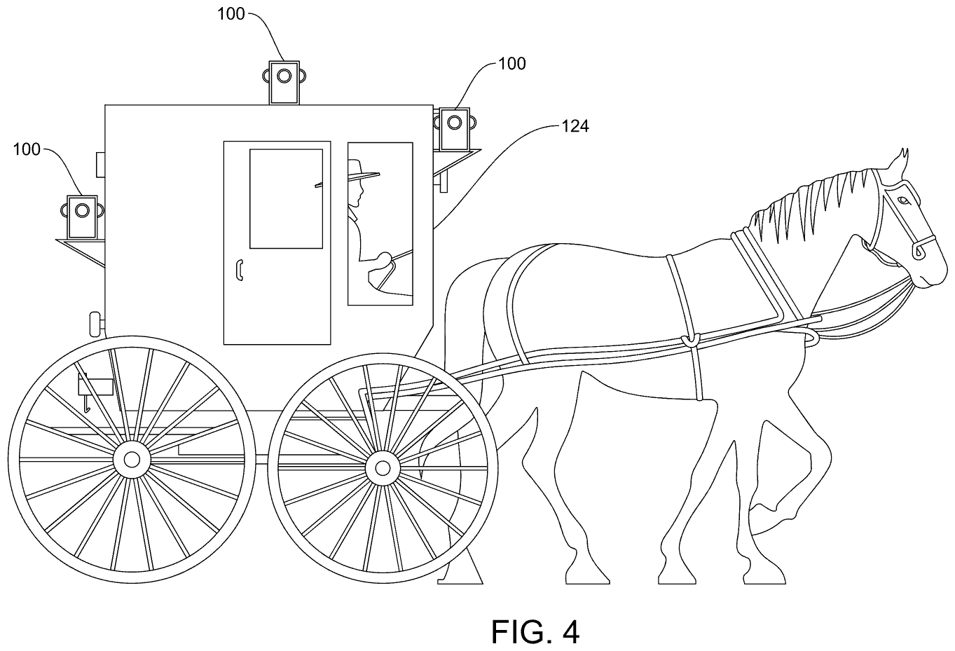

The buggy light 100 features a generally enclosed housing 106 that surrounds a lantern inside. The housing 106 is structured around a vertical axis (corresponding to the vertical orientation of the lantern 102) and includes a top-mounted chimney 108. The chimney 108 allows smoke and heat from the lantern's flame to escape the housing, keeping internal temperatures safe and providing ventilation for an open-flame light source. Each side of housing 106 has an aperture 110, with one aperture on each face of a rectangular housing, or multiple around a circular housing, aligned with the lantern's light source 104. Fitted into each aperture 110 is a lens 118, which focuses or directs the light from the lantern outward. On the exterior of each lens 118, a removable lens cover 120 may be provided. The lens covers 120 can be clear or colored filters; in typical use for road safety, different sides have different colors (for example, a red lens cover 120 on the rear-facing side, a yellow lens cover 120 on the top, and a clear lens cover 120 on the front) to meet visibility and color requirements. The housing 106 thus serves to protect the lantern and internal mechanism from wind and weather, while directing the light through lenses and lens covers as needed for visibility. In FIG. 1, only one side of the housing is visible, but it will be understood that the housing 106 generally has apertures 110, lenses 118, and lens covers 120 on the relevant sides (front, rear, and top in one example configuration). The overall size and shape of housing 106 are such that it can be mounted to a buggy (as shown in FIG. 4) in a stable manner, for example at the rear of the vehicle 124.

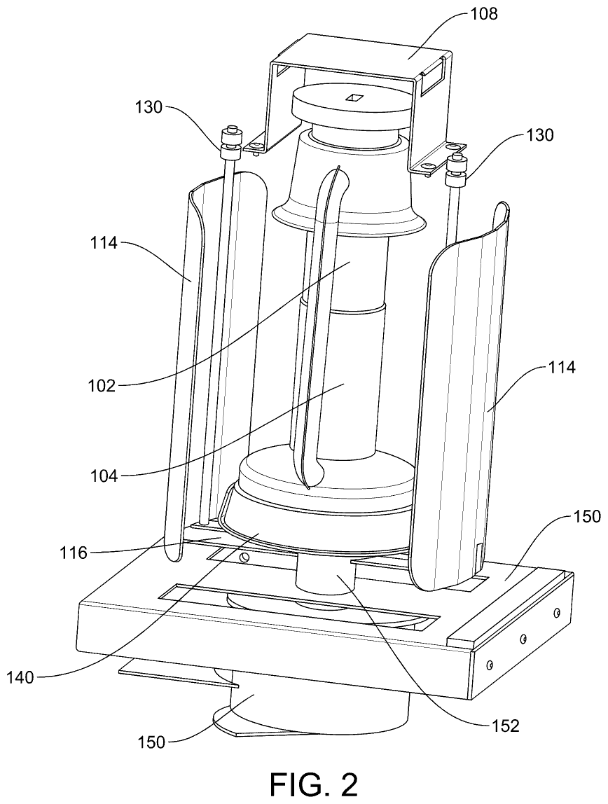

FIG. 2 shows an internal view of the buggy light 100 with the front portion of the housing cut away to reveal the components inside. Inside the housing 106, a lantern 102 is held vertically on a stationary platform 140. The lantern 102 contains a light source 104, which in a preferred embodiment is an open flame, such as from a kerosene lamp wick, that produces a steady light. The lantern 102 is secured in place on the platform 140 by clamps or other retaining means (not shown) so that it will not shift or tip during use; this important for a flame-based light in a moving vehicle. The platform 140 itself is supported by one or more vertical supports 130 that descend from the top of the housing or attach to the housing walls, keeping the platform suspended within the housing. The housing includes a bottom base 146 (essentially a floor), which has a central hole or bearing through which a drive shaft 152 passes. The drive shaft 152 extends vertically upward from a motor 150 positioned below (or on) the base 146. The upper end of drive shaft 152 is attached to an eclipser 112 assembly inside the housing. In the embodiment shown, the eclipser 112 comprises a horizontal cross-arm or support arm 116 mounted to the rotating shaft, with two opposing shields 114 at its ends. Each shield 114 is a generally vertical panel or blade that, as it rotates with the shaft, will periodically align between the lantern 102 and a given aperture 110. In FIG. 2, one shield 114 can be seen positioned such that it would block light toward one side of the housing. As the motor 150 operates, it rotates the drive shaft 152 (and thus the eclipser arm 116 and shields 114) about the vertical axis of the lantern. This rotation causes each shield 114 to sweep around the lantern 102. An observer at a fixed position outside the buggy light will see the lantern's light alternately appear and disappear as a shield passes in front of the aperture 110 on that side. In effect, the eclipser 112 intermittently blocks and unblocks the light from the lantern, creating a blinking or flashing light output. Because two shields 114 are used opposite each other in this embodiment, each full rotation of the eclipser produces two blocking events for any given direction (i.e., the light is eclipsed twice per rotation for someone looking from one side). The rotation speed can be set such that the resulting flash frequency meets legal requirements (for instance, a few flashes per second or a specific number of flashes per minute as mandated by regulations).

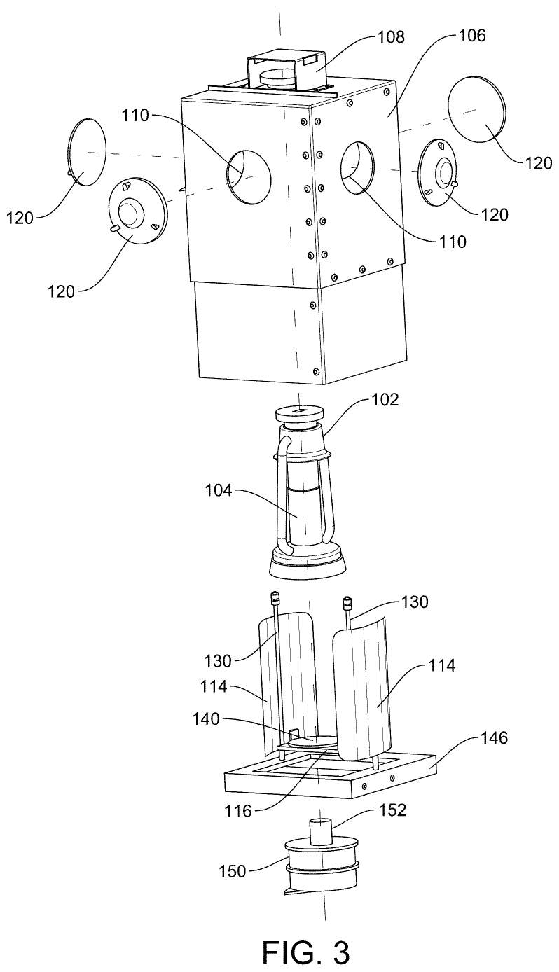

FIG. 3 provides an exploded view of the buggy light assembly 100, illustrating how the components align within the housing 106. In this diagram, the relative positions of the lantern 102, platform 140, support rods 130, eclipser 112 (with its arm 116 and shields 114), motor 150, and drive shaft 152 can be seen in spaced relation. The eclipser 112 fits around the lantern 102 and rotates freely about it. The motor 150, which may be mounted beneath base 146 or integrated into it, connects to the eclipser 112 via the drive shaft 152 that passes through the base 146. The lenses 118 and lens covers 120 would be mounted in the apertures of housing 106 (not explicitly shown in FIG. 3 for simplicity). FIG. 3 demonstrates the assembly order and how these parts cooperate to produce the flashing effect when fully assembled (as described with FIG. 2).

FIG. 4 shows the buggy light 100 in use on an animal-drawn vehicle 124, specifically a horse-drawn buggy. The housing 106 is affixed to the rear of the buggy (for example, by brackets or straps, not shown) such that the rear lens cover 120 (which may be red) faces toward the rear of the buggy, the front lens cover 120 (which may be clear) faces forward, and the top lens cover 120 (which may be yellow) faces upward. In this mounted position, the buggy light 100 provides a red flashing light to the rear (through the red-tinted cover) and a yellow flashing light upward (through the top cover), as well as a white light forward through the clear front cover. These correspond to the typical required lighting: a flashing yellow warning visible from behind and above, a red tail light or reflector for rear visibility, and a forward white light for oncoming traffic. The lantern's chimney 108 extends upward from the housing to safely vent smoke above the buggy.

Importantly, all of these lights originate from the single internal lantern 102. The rotating eclipser 112 ensures that to an observer in any given direction, the light appears to flash on and off, mimicking the effect of modern electric flashing lights but achieved with a purely mechanical, non-electric system. The buggy light 100 can be sized and positioned so as not to interfere with the operation of the buggy or the horse, and it can be quickly attached or detached as needed.

To accommodate Amish religious requirements, the motor 150 in the preferred embodiment is a spring-driven mechanism. In one example, motor 150 is a wind-up spring motor (similar to those used in old clocks or music boxes) that, when fully wound, can drive the eclipser 112 for a period of about 30-45 minutes before needing to be rewound. The use of a wound spring means no electricity or combustion engine is required to rotate the eclipser. A consistent rotation rate can be maintained via a governor or gear assembly (for instance, a set of gears or a centrifugal governor) to ensure that the flashing frequency stays within legal limits. The rate of rotation must cause the buggy light to blink at the required interval (for example, a steady periodic flash easily visible to other drivers). Where community rules permit other solutions, other religiously compliant means may be used to power the motor 150. For example, in another embodiment, the motor 150 could be a weight-driven mechanism, such as a pendulum clock, a heavy weight slowly descends and via pulleys or gears turns the drive shaft 152. Such a weight would need to be re-raised (reset) periodically by the user, but it provides a steady rotation without any electricity. In yet another embodiment intended for communities or applications where limited technology is acceptable, the motor 150 may be an electric motor powered by a battery or a solar panel. In a battery-powered configuration, a small electric motor could rotate the eclipser; the battery might be rechargeable (possibly charged by the solar panel or by removing and charging from an external source). This would still avoid direct connection to the electrical grid, which in some cases might be acceptable to certain Amish sects or could be used by non-Amish users of the device. It should be noted, however, that the primary design is intended to be non-electric. Additionally, various mechanical transmissions such as gear trains, belt and pulley systems, or friction drives (represented generally as gear assembly) can be incorporated to adjust the rotation speed or to link the motor to the eclipser in an optimal way. For instance, a gear reducer can increase torque and stabilize the spinning rate of the eclipser 112, ensuring that the flash rate stays roughly constant even as the spring unwinds. In all embodiments, the goal is to produce a flashing (blinking) light output using a non-electric light source 104 (e.g., a flame) and a mechanical interrupter (eclipser 112). This approach fulfills modern safety requirements (flashing, high-visibility lighting including specified colors) while respecting the religious prohibition on using electric lighting.

While the buggy light apparatus, system, and method have been described above in detail with reference to specific embodiments (including particular configurations and materials), it will be understood by those skilled in the art that various changes and substitutions can be made without departing from the spirit and scope of the invention. For example, the shape of the housing 106 or the number of shields 114 on the eclipser could be modified, different gearing mechanisms could be used to achieve the same flash rate, or the device could be adapted to other types of vehicles that require non-electric signaling. These and other modifications are considered within the scope of the invention. It is intended, therefore, that the foregoing description is illustrative of specific embodiments and not limiting, and that the scope of the invention is defined by the following claims and their legal equivalents.

1. A buggy light comprising:
a) a lantern having a light source, the lantern being oriented vertically within the buggy light, wherein the light source comprises a flame fueled by a combustible fuel;
b) a housing surrounding the lantern about a vertical axis, the housing including a chimney for venting combustion byproducts from the lantern;
c) one or more apertures defined in the housing and aligned with the light source of the lantern;
d) one or more lenses each disposed in a respective aperture, allowing light from the light source to pass outward through the housing;
e) an eclipser rotatable about the vertical axis and positioned around the lantern, the eclipser including at least one shield that intermittently blocks light from the light source from passing through the one or more apertures as the eclipser rotates; and
f) a non-electric mechanical motor operatively connected to the eclipser to rotate the eclipser in full continuous revolutions about the lantern, thereby causing the shield to alternately unblock and block light from the lantern,
wherein the buggy light includes no electric light source.

2. (canceled)

3. The buggy light of claim 1, further comprising one or more lens covers mounted over the one or more lenses, wherein the lens covers include at least one red lens cover oriented toward a rear side of the housing and at least one yellow lens cover oriented toward a lateral side of the housing to provide colored light in different directions.

4. The buggy light of claim 1, wherein the housing includes the chimney extending upward from the housing to exhaust smoke and heat from the lantern.

5. The buggy light of claim 1, wherein the eclipser comprises a horizontal support arm and two oppositely positioned shields mounted on the support arm, such that as the eclipser rotates, the two shields alternately cover and uncover the light source in any given direction.

6. The buggy light of claim 1, wherein the non-electric mechanical motor is a spring-driven motor that requires winding by a user to store energy.

7. The buggy light of claim 1, wherein the non-electric mechanical motor is a weight-driven mechanism that uses a descending weight to rotate the eclipser.

8. The buggy light of claim 1, further comprising a gear or pulley assembly operatively connected between the non-electric mechanical motor and the eclipser to regulate a rotation speed of the eclipser for a desired flashing rate.

9. A method of providing a flashing warning light for an animal-drawn vehicle, the method comprising:
a) providing a lantern having a light source that is a flame fueled by a combustible fuel as an illumination means;
b) placing the lantern within a housing that surrounds the lantern and includes one or more apertures and lenses to direct light outward;
c) rotating an eclipser in full continuous revolutions around the lantern using a non-electric mechanical motor so that the eclipser periodically blocks light from the light source from passing through the apertures; and
d) thereby emitting a blinking light from the housing that is visible from outside the vehicle as a flashing warning signal,
wherein the method is performed using a buggy light that includes no electric light source.

10. The method of claim 9, wherein rotating the eclipser is powered by a wound spring mechanism in the non-electric mechanical motor, the spring being wound by a user prior to operation to drive the eclipser.

11. The method of claim 9, further comprising mounting the housing on an exterior rear portion of the animal-drawn vehicle such that the light source projects to the front, rear, and sides of the vehicle through the lenses.

12. The method of claim 9, further comprising installing a red lens cover over an aperture of the housing facing rearward and a yellow lens cover over an aperture of the housing facing toward a lateral side, so that the method produces a flashing red light toward the rear of the vehicle and a flashing yellow light toward a side of the vehicle.

13. An animal-drawn vehicle, comprising a buggy light attached thereto, the buggy light including:
a) a lantern with a light source that is a flame fueled by a combustible fuel, mounted in a vertical orientation;
b) a housing enclosing the lantern, the housing having one or more apertures with corresponding lenses through which light from the lantern is emitted;
c) an eclipser positioned within the housing and rotatable about the lantern, the eclipser having at least one shield arranged to intermittently obscure the light from the lantern; and
d) a non-electric mechanical motor operatively coupled to the eclipser to rotate the eclipser in full continuous revolutions and cause the light source to appear to flash on and off to an external observer,
wherein the buggy light includes no electric light source.

14. The animal-drawn vehicle of claim 13, wherein the non-electric mechanical motor of the buggy light is a spring-driven motor that must be manually wound to operate.

15. The animal-drawn vehicle of claim 13, wherein the buggy light comprises a red lens cover oriented toward the rear of the vehicle and a yellow lens cover oriented toward a lateral side of the vehicle, such that rotation of the eclipser causes a flashing red signal to be visible from behind the vehicle and a flashing yellow signal to be visible from the side of the vehicle.
